(19) United States
(12) Patent Application Publication
(10) Pub. No.: US 2002/0174134 A1
(43) Pub. Date: Nov. 21, 2002

(54) Computer-user activity tracking system and method

(76) Inventor: Gene Goykhman, Toronto (CA)

Correspondence Address: BIRCH STEWART KOLASCH & BIRCH, PO BOX 747, FALLS CHURCH, VA, 22040-0747, US

(21) Appl. No.: 09/860,673

(22) Filed: May 21, 2001

(51) Int. Cl. G06F 17/60; G06F 15/173

(52) U.S. Cl. 707/104.1; 705/32

(57) ABSTRACT

A method and system for monitoring and tracking the activities of a user of a computer. Associations are established between the states of certain computer system parameters and specific activities. The current activity of the user is then determinable by the system based upon the current state of the computer system. As the state of the computer system changes, changes in the user's activity are monitored and tracked. The activities are tracked in conjunction with time so as to record the time spent on each activity.

### FIELD OF THE INVENTION

This invention relates to the field of user-interactive computers. More specifically, the invention relates to a system and method for monitoring and tracking the activities engaged in by a user of a computer.

### BACKGROUND OF THE INVENTION

User-interactive computers have become almost universal in the office work environment. Most employees use a computer daily in their work to accomplish the majority of their tasks. In addition to performing work functions, computers are used to facilitate communication and scheduling in the modern office environment. Employees in a typical office use their computers for word-processing, accounting, e-mail, scheduling, Internet and a multitude of applications specific to their jobs.

The network architecture, operating system and specific application programs in a particular office can vary widely; however, almost all workplace environments involve a network of personal computers running a basic set of e-mail, Internet, scheduling, spread-sheet and word-processing computer programs. In addition, specific employees may have accounting software, programming software, graphic design software or other job-specific software. The operating systems in use today permit multi-tasking, which allows users to operate several different application programs at once on a single computer and to easily switch between application programs.

Accordingly, in a computerized office environment, employees can engage in a number of different tasks on their computers. Employees can also use their computers to perform specific tasks for a number of different projects, clients or administrative duties. For instance, an employee may use his or her word-processing software to develop documents for a number of distinct projects. One can characterize the use of different computer programs or the use of a computer program for different projects or functions as distinct ‘activities’ of the user. For a variety of reasons, it can be advantageous for an organization to track a computer-user's activities.

The user's activities can be tracked in connection with a number of variables, the most important of which is likely time. By tracking time in connection with a user's activities on a computer, one can monitor how much time is spent on particular activities. This can be essential information for project management, project assessments, efficiency analysis, billing and organizational management. A user's activities can also be tracked in connection with other variables such as network or processor loading.

In order to compile this kind of information in the past, an organization has relied upon the individual computer-user to manually track his or her activities. This method has significant drawbacks, the most apparent one being the potential for human error in accurately recording the activity and in recognizing changes in activities. Manual activity tracking is also costly because it requires active user involvement in recording the activities. These drawbacks are amplified and exacerbated as the user is required to track associated variables along with the activities, such as the time spent on each activity. Therefore, it would be helpful if the user's computer could assist the user in tracking activities and associated variables.

Such systems have been developed; however, prior computerized activity tracking systems have still required the user to recognize a change in activities, to select his or her current activity from a list of activity descriptions and to manually begin and end an associated timer. This type of system alleviates some of the problems with the human error and cost related to entirely manual systems, but still requires a significant human interaction and, thus, has most the drawbacks of previous systems.

Accordingly, what is needed is a system and method of tracking a computer-user's activities that addresses the drawbacks of previous systems.

### BRIEF SUMMARY OF THE INVENTION

The present invention provides a system and method of monitoring and tracking a user's activities on a computer with a reduced amount of user involvement. More specifically, the present invention provides a system and method that employs the user's computer to assist in tracking the user's activities and any associated variables.

In a first aspect, the present invention comprises a plurality of activity identifiers, and means for associating each of the activity identifiers with one of the activities; means for interrogating a system context parameter, where the system context parameter is provided by the computer and has a plurality of states; means for determining the state of the system context parameter, the state being indicative of the activity of the user on the computer; means responsive to a change in the state of the system context parameter for selecting the activity identifier corresponding to the state of the system context parameter; and means for tracking the activity of the user associated with the selected activity identifier.

In a second aspect, the present invention comprises a number of activity identifiers each corresponding to one of the activities; a link component for linking each activity identifier with the state of the system parameter that corresponds to the same activity; an interrogation component for determining the present state of the system parameter; a selector component for selecting the activity identifier corresponding to the present state of the system parameter; and a tracing component for tracing the user's activity associated with the selected activity identifier.

In a third aspect, the present invention comprises the steps of providing a plurality of activity identifiers; associating each of the activity identifiers with one of the activities; interrogating the system context parameter to determine the state of the system context parameter, the state being indicative of the activity of the user on the computer; selecting the activity identifier corresponding to the state of the system context parameter; and tracking the activity of the user associated with the selected activity identifier.

In a fourth aspect, the present invention comprises the steps of associating an activity with an activity identifier; associating the activity identifier with a state of the system parameter, the state of the system parameter being indicative of the activity corresponding to the activity identifier; monitoring the present state of the system parameter; determining the activity identifier corresponding to the present state of the system parameter; and storing the determined activity identifier, and tracking the user's activity on the computer based on the activity identifier.

In a fifth aspect, the present invention comprises a computer program product comprising a recording medium and means recorded on the medium for instructing the computer system to perform the steps of providing a plurality of activity identifiers; associating each of the activity identifiers with one of the activities; interrogating the system context parameter to determining the state of the system context parameter, the state being indicative of the activity of the user on the computer; selecting the activity identifier corresponding to the state of the system context parameter; tracking the activity of the user associated with the selected activity identifier.

Other aspects and features of the present invention will become apparent to those ordinarily skilled in the art upon review of the following description of specific embodiments of the invention in conjunction with the accompanying figures.

### BRIEF DESCRIPTION OF THE DRAWINGS

Reference will now be made, by way of example, to the accompanying drawings which show a preferred embodiment of the present invention, and in which:

FIG. 1 shows in diagrammatic form a system according to the present invention for tracking a user's activities and the time the user spends on each activity;

FIG. 2 shows in flow chart form an activity monitoring method according to the present invention;

FIG. 3 shows in flow chart form an activity identifier selection process according to the present invention;

FIG. 4 shows in diagrammatic form a screen shot including an activity tracking window according to the present invention;

FIG. 5 shows in diagrammatic form an activity tracking window according to the present invention;

FIG. 6 shows in diagrammatic form a screen shot including an activity tracking window displaying a countdown icon according to the present invention;

FIG. 7 shows in diagrammatic form an activity tracking window displaying a selected activity descriptor according to the present invention; and

FIG. 8 shows in diagrammatic form a screen shot including an activity tracking window in use in conjunction with a mouse for associating an activity with a system parameter, according to the present invention.

### DETAILED DESCRIPTION OF THE PREFERRED EMBODIMENTS

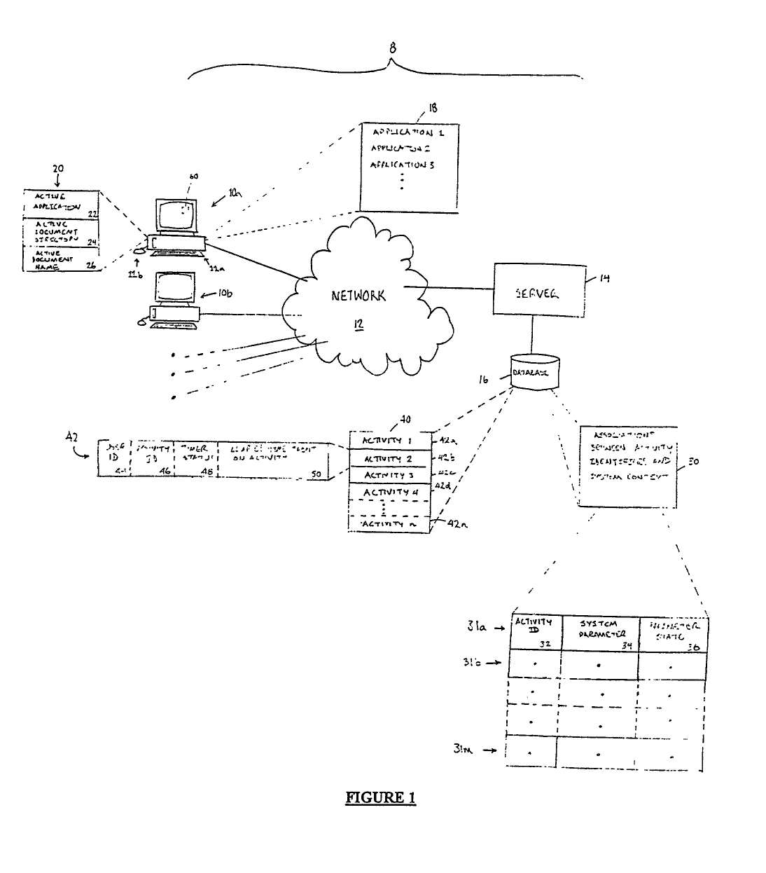

Reference is first made to FIG. 1 which shows, in diagrammatic form, a computer-user activity tracking or monitoring system 8 according to the present invention. The activity tracking system 8 includes one or more personal computers 10 or workstations, indicated individually as 10a and 10b, and which may be connected in a network 12. If connected in a network 12, the network 12 preferably includes a server 14, which maintains a database 16. The network 12 and its operating system permit file sharing among the server 14 and the computers 10.

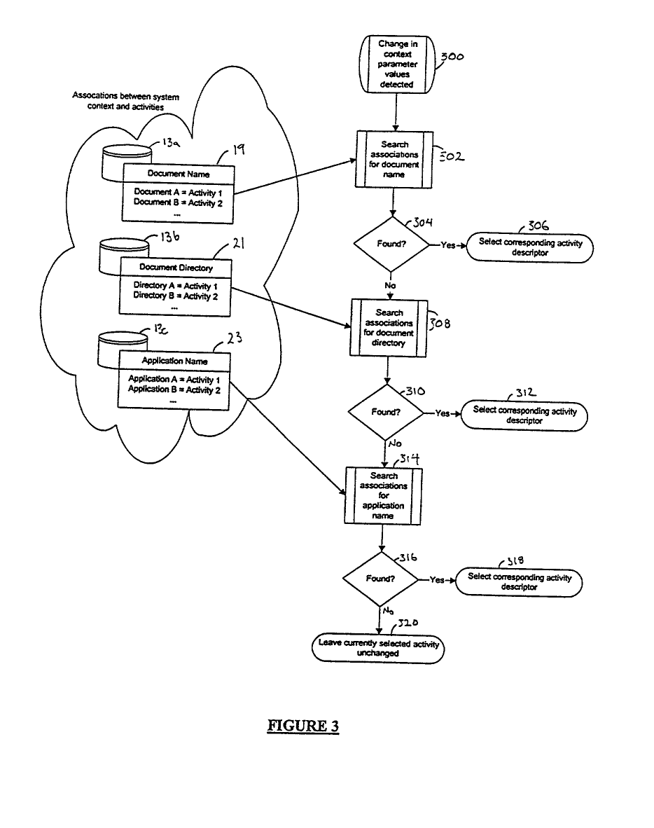

Each of the computers 10 is operated by a user and is capable of running a variety of application programs 18 at the same time. The application programs 18 are loaded into computer (RAM) memory 13 (FIG.3) and executed by the central processing unit(s) (CPU) for the computer 10. Within some application programs 18, such as a word-processor or a software development tool, there will be a particular document 19 (FIG. 3) that the user is creating or editing and this document 19 is stored in memory 13. That particular document may be located within a particular directory 21 (FIG. 3). Other application programs 23 (FIG. 3), such as an e-mail programs, may not have an identifiable document directory or a particular document associated with the user's activity.

The computers 10 may comprise Intel-based personal computers running Microsoft Windows™ operating system, but it will be appreciated that the activity tracking system 8 may utilize other types of computers or workstations, or run on other operating systems, for example Apple O/S™, BeOS™, PalmOS™, Linux™ and all major versions of Unix™. The computers 10 may comprise personal computers, hand-held or wireless personal digital assistants (PDAs), cellular phones, pagers or any other computing devices upon which multiple applications or applets may be operating.

In the context of the present invention, the activity tracking system 8 utilizes a number of system context parameters 20, with each system context parameter 20 having a state which provides the system context for the computer 10 as will be described in more detail below. The system context is indicative of the current activity of the user on the computer 10. In the following description, the system context parameters 20 comprise an active application parameter 22, an active document directory parameter 24 and an active document name parameter 26, but it will be appreciated that other system context parameters 20 may be used. For example, if a user is editing a letter using a word processing application program such as Microsoft Word™, then the state for the active application parameter 22 is Microsoft Word™; the state for the active document directory parameter 24 is the directory in which the letter is saved; and the state for the active document name parameter 26 is the document name associated with the letter. On the other hand, if the user is composing e-mail using an e-mail application program such as Microsoft Outlook™, then the state for the active application parameter 22 is Microsoft Outlook™ and the state for the active document name parameter 26 is Inbox, but for Microsoft Outlook™ there is no document directory so the state for the active document directory parameter24 is nothing. The activity tracking system 8 interrogates the Microsoft Windows™ operating system to obtain the state of each the system context parameters 20, as described in more detail below.

The database 16 maintained by the server 14 (or locally on the computer 10) comprises two tables: an associations table 30 and an activities table 40. The associations table 30 lists associations between the activities engaged in by the user and the system context for the computer 10, where the system context is the particular state of the system context parameters 20 corresponding to the activity engaged in by the user. The activities table 40 has entries 42 for each activity to keep track of the elapsed time spent on each activity. As shown in FIG. 1, each activity that the activity tracking system 8 is configured to track has an entry 31, shown individually as 31a, 31b, . . . , 31m, in the associations table 30. Each entry 31 in the associations table 30 includes an activity identifier 32, a system parameter indicator 34 and a system parameter state 36. The system parameter state 36 provides the state of the system context parameter 20 that corresponds to the activity being engaged in by the user. For example, the first entry 31a in the associations table 30 is for the activity “engaging in e-mail” and comprises a unique activity identifier 32, a system parameter indicator 34 and a parameter state 36. The system parameter indicator 34 designates the active document name parameter 26 as the relevant system context parameter 20, and the parameter state 36 indicates the state of the active document name parameter 26 as “Inbox”. In a further example, the entry 31 for the activity “doing accounting” will also have a unique activity identifier 32, a system parameter indicator 34 and a parameter state 36. For the activity “doing accounting”, the system parameter indicator 34 identifies that the active application parameter 22 is the relevant system context parameter 20, and the parameter state 36 indicates that state of the active application parameter 22 is Microsoft Excel™. Further details on the creation of the associations table 30 and the linking of activities with the system context for the computer 10 through the system context parameters 20 are described below.

Referring again to FIG. 1, the activities table 40 contains an entry 42 for each activity, shown individually as 42a, 42b, 42c, 42d, . . . 42n. Each entry 42 for an activity in the activities table 40 includes a user identifier 44, an activity identifier 46, a timer status indicator 48 and a time log 50. The activity identifiers 46 in the activities table 40 correspond to the activity identifiers 32 stored in the associations table 30. The user identifier 44 associates a particular activity with a particular user. The user identifier 44 is necessary because there may be multiple users within the activity tracking system 8 that could be performing the same activity. For example, multiple users may be “engaging in e-mail”; accordingly, a separate “e-mail” activity, i.e. entry 42, is provided for each user. The timer status indicator 48 comprises a binary digit indicating whether the activity is currently selected or not. Each user can only have one of his or her activities selected at a particular time. The time log 50 for an activity is a running total of the time elapsed during which the user was engaged in that particular activity.

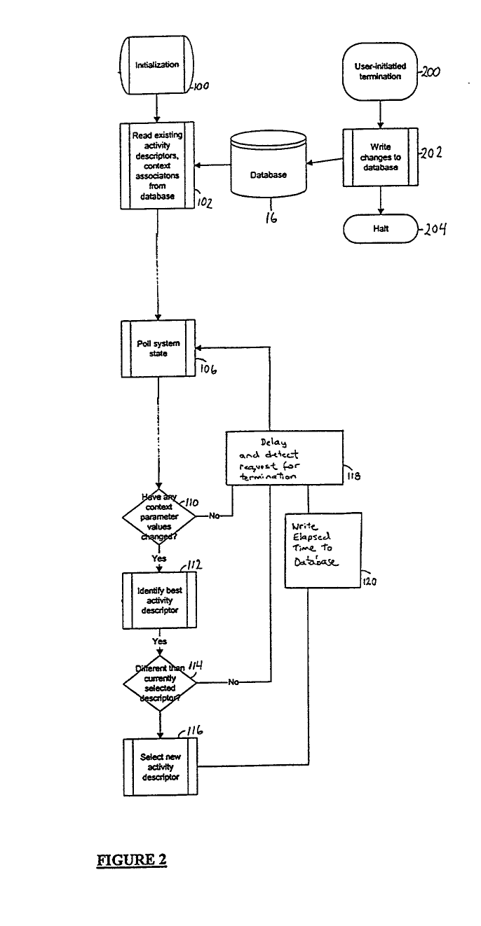

The operation of the activity tracking system 8 is now described with reference to the method steps shown in flow chart form in FIG. 2. Operation begins in step 100 with the initialization of basic variables and parameters. In step 102, the activity tracking system 8 accesses the database 16 to locate the pre-defined activities and the relevant system context parameters 20. The activity tracking system 8 also loads the associations table 30 and the user-specific activities table 40 into the random-access memory (RAM) of the computer 10.

After this initial set-up, the activity tracking system 8 polls the system context parameters 20 (FIG. 1) in step 106 to determine the state of each system context parameter 20. In step 110, the activity tracking system 8 checks to see if the state of any of the system context parameters 20 has changed. If not, then the activity tracking system 8 returns to step 106 to poll the system context parameters 20 again. If, in step 110, it is determined that the state of the system context parameters 20 has changed, then in step 112 the activity tracking system 8 uses the associations table 30 (FIG. 1) to determine the most likely activity being engaged in by the user, as indicated by the system context. The determined activity is represented by its activity identifier 32 (FIG. 1). In step 114, the activity tracking system 8 assesses whether the activity identifier 32 determined in step 112 is different from the activity identifier 32 for the current activity, i.e. the current activity identifier 32. If not, then the activity tracking system 8 returns to step 106 to poll the system context parameters 20 again. If the activity identifier 32 determined in step 112 is different, then in step 116 the activity tracking system 8 updates the current activity identifier 32 to reflect the change. The activity tracking system 8 also de-selects the previous activity 42 (FIG. 1) and selects the new corresponding activity 42 in the activities table 40. The activity tracking system 8 then returns to step 106 to poll the system context parameters 20 again.

As shown in FIG. 2, a delay 118 is introduced into the return path before step 106 so that the system context parameters 20 (FIG. 1) are only polled once every second, or at another frequency depending upon the elapsed time resolution desired. Continuous polling without any delay may cause an undue burden upon the resources of the computer 10. If the activity tracking system 8 has detected a change in activities and selected a new activity identifier 32 (FIG. 1) in step 116, then before the delay 118, in step 120 the activity table 40 is written to the database 16. This ensures that the database 16 maintains a record of the elapsed time spent on the activities 42 and ensures the activity tracking system 8 does not lose that information in the event of a system crash or unexpected reboot of the computer(s) 10.

Thus, the activity tracking system 8 repeatedly polls the system context parameters 20 to monitor the system context of the computer(s) 10 for changes that would indicate a change in the user's activity. As it detects changes in the user's activity, it deselects the previous activity 42 (FIG. 1) and selects the new activity 42. To stop the activity tracking system 8 from operating the user initiates a termination request. A request for termination is detected during the delay 118. Referring again to FIG. 2, if the user requests termination (step 200), then the activity tracking system 8 moves to step 202. At step 202, the activity tracking system 8 writes any changes in the associations table 30 to the database 16. At step 204, the activity tracking system 8 formally stops.

The process of selecting an appropriate activity identifier 32, shown in steps 112-116 of FIG. 2, is described in more detail below with reference to the flow chart shown in FIG. 3. As described above, the system context parameters 20 being polled comprise the active application parameter 22, the active document directory parameter 24 and the active document name parameter 26. These system context parameters 20 have varying levels of specificity depending on the activity being performed on the computer 10. For example, an activity as general as “doing accounting” will correspond to the active application parameter 22 and have a parameter state 36 (for example, the Microsoft Excel™ spreadsheet program) in the associations table 30. Whenever a user is working with the Microsoft Excel™ spreadsheet program, regardless of the specific spreadsheet document or document directory, that user is “doing accounting”. A more specific activity would be “working on Jones brochure”. This activity will correspond to the active document name parameter 26 and have a parameter state 36 (in the associations table 30, FIG. 1) of the document name “Jones_brochure01.doc”. Whenever the active document name 26 is “Jones_brochure01.doc” the associated activity 31 for the user is “working on Jones brochure”. In this regard, an activity that is linked to a particular document rather than an application program (e.g. Microsoft Word™ word processor) is a more narrowly defined activity and, as such, the activity tracking system 8 initially evaluates whether it can identify an activity based upon the active document name parameter 26. If not, then it tries to select an activity based upon the active document directory parameter 24, and then finally the active application parameter 22.

Referring to FIG. 3, in step 300, the activity tracking system 8 checks the system context parameters 20 and if a change in the state of one or more of the system context parameters 20 (i.e. the active application parameter 22, the active document directory parameter 24, the active document name parameter 26) is detected in step 300, the activity tracking system 8 continues to step 302. In step 302, the activity tracking system 8 checks the associations table 30 to determine if one of the activity identifiers 32 (in the associations table 30—FIG. 1) is associated with the active document name parameter 26 for the system context parameters 20. In step 304, if an activity identifier 32 is located, and it is different from the current activity identifier 32, then it is set as the current activity identifier 32 in step 306, and the activity tracking system 8 returns to checking, e.g. polling, the system context parameters 20 in step 300.

Referring still to FIG. 3, if an activity identifier 32 (FIG. 1) is not located based upon the active document name parameter 26, then the activity tracking system 8 moves to step 308 where it attempts to locate an activity identifier 32 associated with the active document directory parameter 24. At step 310, if a corresponding activity identifier 32 is located, and it is different from the current activity identifier 32, then it is set as the current activity identifier 32, step 312, and the activity tracking system 8 returns to checking, e.g. polling, the system context parameters 20 in step 300.

Finally, if an activity identifier 32 in the associations table 30 (FIG. 1) has not yet been located for the activity document name parameter 26 and the active document directory parameter 24, then at step 314 the activity tracking system 8 checks for an activity identifier 32 associated with the active application parameter 22 (FIG. 1). In step 316, if an activity identifier 32 is found in the associations table 30 then the activity tracking system 8 continues to step 318, else it continues to step 320. At step 318, if the selected activity identifier 32 is different from the current activity identifier 32, then it is set as the current activity identifier 32 and the activity tracking system 8 returns to polling or checking for changes in the system context parameters 20. At step 320, the activity tracking system 8 has failed to locate an activity identifier 32 associated with the current system context (i.e. as defined by the system context parameters 20), so it leaves the current activity identifier 32 as it is and returns to polling the system context parameters 20 for further changes in state.

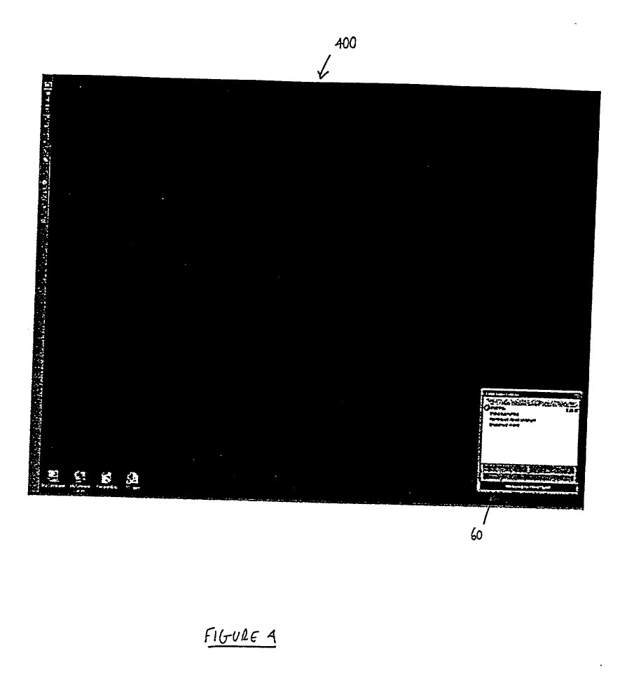

Reference is now made to FIGS. 4 through 8, which in conjunction with the following description illustrate the activity tracking system 8 of FIG. 1 and its operation. In particular, FIG. 4 shows in diagrammatic form a window or screen shot 400 which is displayed by the computer 10. The screen shot 400 includes an activity tracking window 60 for displaying information regarding the operation of the activity tracking system 8.

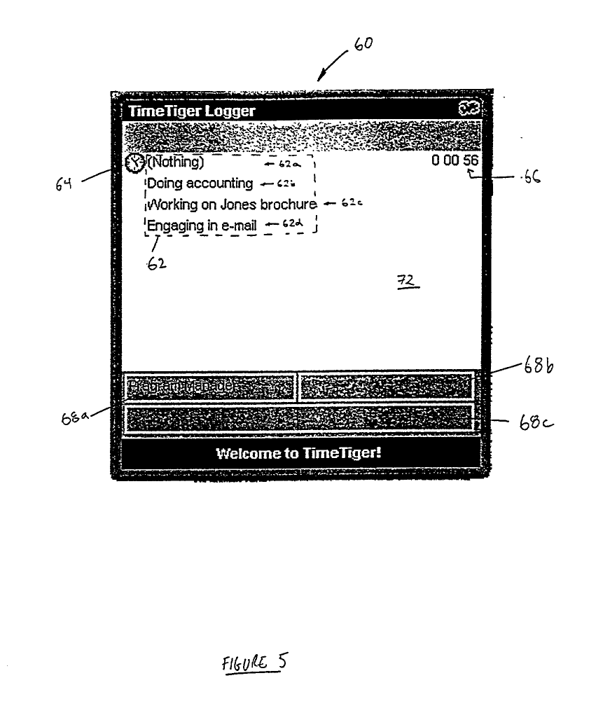

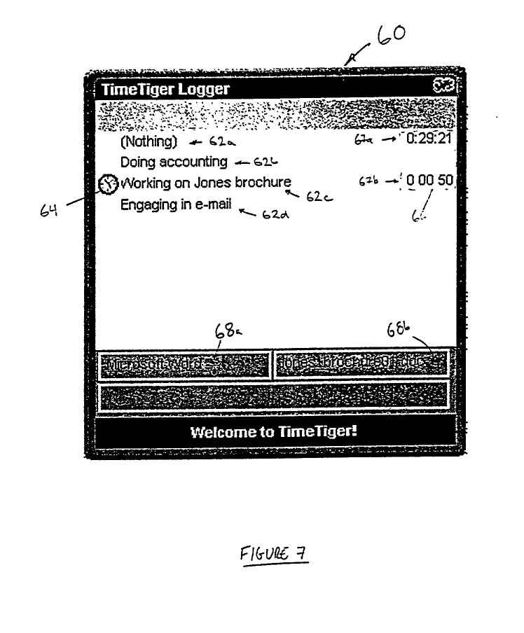

Reference is made to FIG. 5 which shows in diagrammatic form the activity tracking window 60. The activity tracking window 60 includes a background field 72 upon which is displayed a list of activity descriptors 62. Each activity identifier 32 (FIG. 1) corresponds to one of the activity descriptors 62 which includes a textual description of the corresponding activity. The activity descriptors 62, indicated individually by references 62a, 62b, 62c and 62d, includes an activity descriptor “Nothing” 62a so as to track periods of inactivity by the user. The other activity descriptors listed include “Doing accounting” 62b, “Working on Jones brochure” 62c and “Engaging in e-mail” 62d. Also displayed in the background field 72 is an indicator 64 and an elapsed time count 66. The indicator 64 indicates the current selected activity. The elapsed time count 66, as shown in FIG. 7, comprises an elapsed time count field 67, indicated individually as 67a and 67b, which tracks the time for each associated activity, i.e. activity descriptor 62.

The use of the activity descriptors 62 facilitates interaction with the user. The display of this information permits the user to monitor the operation of the activity tracking system 8, to “fine tune” entries 31 (FIG. 1) in the associations table 30 (FIG. 1), and to create new activities 42 in the activities table 40 (FIG. 1) and associated entries 31 in the associations table 30.

Referring again to FIG. 5, underneath the background field 72 in the activity tracking window 60, there are three system parameter fields 68 that are associated with system context parameters 20. The first parameter field 68 is an active application field 68a, which displays the state of the active application parameter 22, for example “Program Manager”, as shown in FIG. 5; or, for example “Microsoft Word™”, as shown in FIG. 7. The second parameter field 68 is an active document name field 68b, which displays the state of the active document name parameter 26, for example “Jones_brochure.doc”, as shown in FIG. 7. The third parameter field 68 is an active document directory field 68c, which displays the state of the active document directory parameter 24, for example “C:\myfiles\documents\”. Further system parameter fields 68 may added to the activity tracking window 60 to display the states of other system context parameters 20, such as the state of the active document directory parameter 24.

As the activity tracking system 8 selects an activity identifier 32, its corresponding activity descriptor 62 is identified by the indicator 64 within the list of activity descriptors 62 displayed in the activity tracking window 60 to show it has been identified by the activity tracking system 8 as the current activity. The user can then evaluate whether the activity tracking system 8 has selected an appropriate activity descriptor 62 for the current activity. Using an input device, such as the mouse 11b or the keyboard 11a (FIG. 1), the user can change the current activity by manually selecting a different activity descriptor 62 from the list in the activity tracking window 60. The activity tracking system 8 then begins to record the elapsed time the user spends on the selected activity.

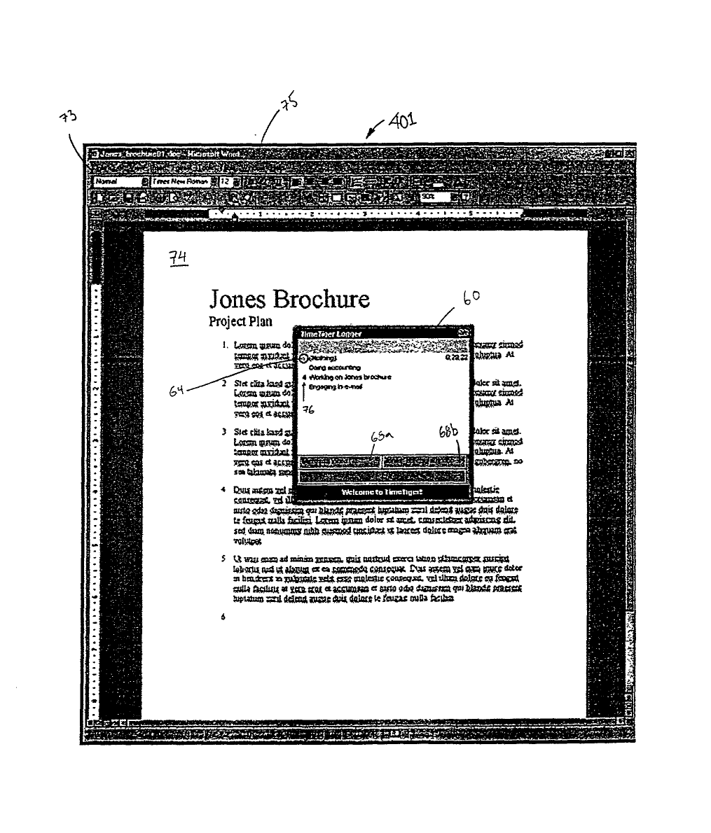

To allow the user sufficient time to evaluate whether the activity tracking system 8 has selected an appropriate activity, the activity tracking system 8 delays implementing the change in the current activity for a brief period of time. During this time, the activity tracking window 60 indicates the new activity selected and displays a countdown icon 76 (as shown in FIG. 6). If the countdown expires without the user objecting to the new activity selected, then the activity tracking system 8 implements the changes.

Reference is next made to FIG. 6, which shows in diagrammatic form a screen shot or window 401 displaying the activity tracking window 60 in conjunction with a newly opened application. The screen shot 401 comprises the Microsoft Word™ word processor application program 73 including a caption bar 75 which indicates that the document “Jones_brochure01 .doc” 74 is open within Microsoft Word™ 73. Within the activity tracking window 60, the active application field 68a indicates that Microsoft Word™ 73 is the state of the active application parameter 22 (FIG. 1), and the active document name field 68b indicates that Jones_brochure01.doc is the state of the active document name parameter 26 (FIG. 1). It will be appreciated that FIG. 6 depicts the state of the activity tracking window 60 after the system context parameters 20 (FIG. 1) have recently changed, so the activity tracking window 60 continues to display the indicator 64 next to the activity descriptor “Nothing” 62a and the countdown icon 76 is displayed next to the activity descriptor “Working on Jones brochure” 62c.

The state of each system context parameter 20 (FIG. 1), i.e. the active application parameter 22 (FIG. 1), the active document directory parameter 24 (FIG. 1) and the active document name parameter 26 (FIG. 1), is determined from the caption bar 75 displayed at the top of the window currently active on the user's computer display. The Microsoft Windows™ operating system permits an application to interrogate the currently active window for the information appearing in its caption bar 75. In general, application programs operating on the Microsoft Windows™ operating system display in the caption bar 75 the name of the application program and, if there is a document open within the application program, the name of the document. Some application programs also display in the caption bar 75 the directory within which the document is saved. The activity tracking system 8 determines the state of the active application parameter 22 and the state of the active document name parameter 26 from the caption bar 75. The caption bar 75, as shown in FIG. 6, displays text regarding the state of the active application parameter 22 and the state of the active document name 26. The activity tracking system 8 parses the text information contained in the caption bar 75 to determine the state of the active application parameter 22 and the active document name parameter 26.

Referring to FIG. 6, the countdown icon 76 indicates that the activity tracking system 8 has determined a new current activity identifier 32 that corresponds to the activity descriptor “Working on Jones brochure” 62c. This activity descriptor 62 corresponds to the current activity of the user, and thus will track the elapsed time that the user spends working on the Jones brochure. If the user does not manually select an alternative activity descriptor 62 before the countdown expires, then the activity tracking system 8 will implement the change to the current activity as described in more detail above.

Referring again to FIG. 7, the activity tracking window 60 is shown after the countdown (i.e. icon 76) has expired without the manual selection of an alternative activity descriptor 62 by the user. As such, the current activity is indicated by the indicator 64 displayed next to the activity descriptor “Working on Jones brochure” 62c. The elapsed time count fields 67 show that time has been tracked in connection with two activities. The elapsed time count field 67a displays the time spent doing “Nothing” and the elapsed time count field 67b shows the time spent “Working on Jones brochure” If the system context parameters 20 do not change, for each second the elapsed time count field 67b will increase or increment to show the elapsed time spent “Working on Jones brochure” (i.e. activity descriptor 62c).

In addition to manually selecting one of the activity descriptors 62, the user can manually create or alter associations in the associations table 30 (FIG. 1) between the activity identifiers 32 (FIG. 1) and the parameter state 36 (FIG. 1) for any of the system context parameters 20 (FIG. 1). Once the user selects the appropriate activity descriptor 62, he or she can manually link its associated activity identifier 32 (FIG. 1) with one of the system context parameters 20 (FIG. 1) shown in the system parameter fields 68 of the activity tracking window 60, for example, by “dragging and dropping” the system parameter field 68 onto the activity descriptor 62 using a mouse. For instance, the user may identify that any time they use the Microsoft Excel™ spreadsheet program they are “doing accounting”, in which case the user may wish to link that activity with the Microsoft Excel™ spreadsheet program. To do this the user clicks upon the system parameter field 68a showing Microsoft Excel™ using the mouse and, holding the mouse button down, “drags” the system parameter field 68a to the activity descriptor “doing accounting” 62b and releases the mouse button. In response, the activity tracking system 8 now updates the associations table 30 (FIG. 1) to indicate that the activity identifier 32 (FIG. 1) corresponding to “doing accounting” is associated with the parameter state 36 (FIG. 1) of Microsoft Excel™ and the system context parameter 20 of the active application parameter 22 (FIG. 1). Thereafter, anytime the user opens the Microsoft Excel™ spreadsheet program, the activity tracking system 8 will recognize that the user is “doing accounting”.

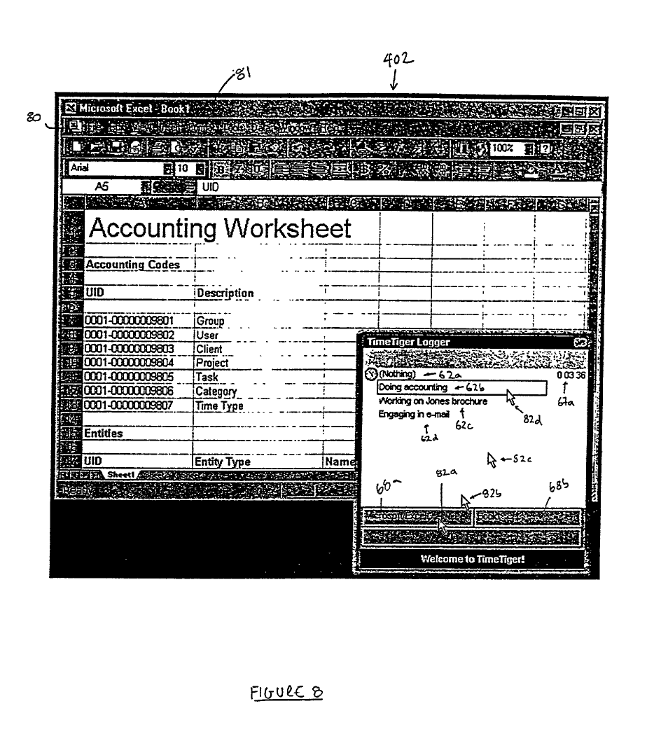

Reference is next made to FIG. 8, which diagrammatically illustrates in more detail the creation of associations between activities and system context parameters 20 (FIG. 1) using the activity tracking window 60. FIG. 8 shows a screen shot or window 402 comprising the spreadsheet program Microsoft Excel™ 80 and the activity tracking window 60. A caption bar 81 displays text information regarding the active application parameter 22 (FIG. 1) and the active document name parameter 26 (FIG. 1). The activity tracking system 8 interrogates the operating system for the computer 10 to obtain the textual information from the caption bar 81. The activity tracking system 8 then parses the textual information to determine the state of the active application parameter 22 and the state of the active document name parameter 26.

The active application field 68a indicates that the state of the active application parameter 22 (FIG. 1) is Microsoft Excel™ 80. To link the descriptor “doing accounting” 62b with Microsoft Excel™ 80 as the state of active application parameter 22, the user positions the mouse pointer 82a over the active application field 68, clicks and holds the mouse button, and moves the mouse pointer to a position over the activity descriptor “doing accounting” 62b, as shown by 82a to 82d. The user then releases the mouse button and the activity tracking system 8 updates the associations table 30 (FIG. 1) to indicate that the activity identifier 32 (FIG. 1) corresponding to “doing accounting” is associated with the active application parameter 22 and the parameter state 36 of Microsoft Excel™ 80.

In addition to permitting the user to manually edit associations for existing activities, according to another aspect the activity tracking system 8 permits the user to establish new activities 42 (FIG. 1) for the activities table 40 (FIG. 1). Within the window 60, the user indicates that he or she would like to create a new activity by clicking the right mouse button while the mouse pointer 82 is positioned over a blank area of the background 72. The activity tracking system 8 then prompts the user to enter an activity descriptor 62. The new activity descriptor 62 corresponds to a new activity identifier 32 (FIG. 1) created by the activity tracking system 8 and stored in the associations table 30 (FIG. 1). Next, an appropriate association to a system context parameter 20 is created by the user by defining the system parameter 34 and also the parameter state 36 that corresponds to the activity, as described above.

Changes made to the associations table 30 during the operation of the activity tracking system 8 are recorded to the database 16, in step 202 of FIG. 2, when the user requests termination of the activity tracking system 8. Thus, any changes to the associations table 30 are preserved for the next operation of the activity tracking system 8. It will be appreciated that a more robust system may be implemented through frequent periodic recording of the associations table 30 in the database 16.

There are a variety of ways to implement the process of selecting an activity identifier 32 by the activity tracking system 8. The method described above, in which the activity tracking system 8 steps through the system context parameters 20 from most specific to least specific looking for a match in the user-created associations table 30 is one method. An alternative method involves scanning the states of the system context parameters 20 for text fragments that correspond to activity descriptors 62. Using an appropriate ranking formula, the best activity descriptor 62 is selected that corresponds to the state of the system context parameters 20, i.e. active application parameter 22, active document directory parameter 24 and active document name parameter 26.

Another alternative technique involves using a correlation matrix built over time based upon the user's selection of particular activity descriptors 62 corresponding to a certain system context. The activity tracking system 8 detects correlations between the state of the system context parameters 20 and the activity descriptors 62 the user selects. In such a way, the activity tracking system 8 learns the correct associations.

Yet another technique involves using a neural matrix linking states of system context parameters 20 with activity identifiers 32. Over time, based on the user selecting certain activity descriptors 62 in the context of particular states of the system context parameters 20, the correct links would be strengthened and incorrect links weakened, allowing the matrix to learn the correct associations.

As described above, the system context parameters 20 for the activity tracking system 8 are the active application parameter 22, the active document directory parameter 24 and the active document name parameter 26. Additional or alternative system context parameters 20 may be used for identifying user activity on the computer 10. Any information that the activity tracking system 8 could obtain from the computer 10 that indicates its current state of operation could be used as a system context parameter 20. Some alternatives include mouse pointer location, currently connected network server, CPU load and ratio of keystrokes to mouse movement.

The above-described embodiment uses periodic active polling to determine the state of the system context parameters 20. As an alternative to periodic active polling, the activity tracking system 8 may request that it be notified by the operating system whenever the state of one of the system context parameters 20 changes, for example through an interrupt-type driven facility. It will be appreciated that such an implementation results in lower overhead because the activity tracking system 8 is not repeatedly using the resources of the computer 10; however, on many existing operating systems, there are some limitations as to the system context parameters 20 about which it can request information.

The activity tracking or monitoring system 8 disclosed herein is applicable to a wide variety of uses. The embodiment of the present invention outlined above contemplates the activity tracking system 8 being used to track the time a user spends on each activity for use in billing or project management. Other uses include recording a user's activities to create an audit trail to be analysed for unauthorized use information; recording the time spent performing specific operations within a software application so as to analyse the usability of the software product and identify confusing components or delays; recording the time spent on applications and the corresponding load on the processor to collect information for computer system design and optimization; and, auditing the use of certain software or documents to obtain information for licensing, confidentiality or purchasing decisions.

Referring back to FIG. 1, the network 12 may comprise any computer network, including the Internet. Alternatively, the network 12 may be eliminated and the database 16 implemented using the computer 10, resulting in a stand-alone system for monitoring and tracking user activities.

The present invention could be implemented using a variety of operating systems, including, but not limited to, all versions of Microsoft Windows™, Apple O/S™, BeOS™, PalmOS™, Linux™ and all major versions of Unix™. Likewise, the programming code used in the present invention could be created using a variety of tools, including, but not limited to, C, C++, Java, Pascal, Visual Basic™, Delphi, and others. The range of configurations, operating systems, programming languages, programming alternatives and applications possible will be understood by one skilled in the art.

The present invention may be embodied in other specific forms without departing from the spirit or essential characteristics thereof. Certain adaptations and modifications of the invention will be obvious to those skilled in the art. Therefore, the above discussed embodiments are considered to be illustrative and not restrictive, the scope of the invention being indicated by the appended claims rather than the foregoing description, and all changes which come within the meaning and range of equivalency of the claims are therefore intended to be embraced therein.

What is claimed is:

1. A system for monitoring activity of a user on a computer, the computer allowing the user to engage in a number of activities and the computer providing a system context parameter having a plurality of states indicative of the activities engaged in by the user on the computer, said system comprising:
(a) a plurality of activity identifiers, and means for associating each of said activity identifiers with one of the activities;
(b) means for interrogating the system context parameter, and means for determining the state of the system context parameter, and the state being indicative of the activity of the user on the computer;
(c) means responsive to a change in the state of the system context parameter for selecting the activity identifier corresponding to the state of said system context parameter; and
(d) means for tracking the activity of the user associated with said selected activity identifier.

2. The system as claimed in claim 1, wherein said means for tracking includes a timer component, said timer component being responsive to changes in the state of said system context parameter for timing the time spent by the user when engaged in the activity indicated by the activity identifier.

3. The system as claimed in claim 2, wherein said means for tracking further includes a component for determining a change in the activity being performed by the user, and said timer component being responsive to the change in the activities for timing the time spent by the user on the current activity, and the subsequent activity.

4. The system as claimed in claim 1, wherein said means for tracking comprises means for tracking multiple users engaged in one or more of the activities on the computer, said means for tracking multiple users comprising a component for associating each of the users for the computer with the activity identifier for the activity engaged in by that user on the computer.

5. The system as claimed in claim 4, wherein said component for associating each of the users comprises an activities table, said activities table having an entry for each of the activities, and each of said entries including a user identifier, a user activity identifier, and a time log, said user identifier providing an identifier for each user on the computer, and said user activity identifier corresponding to the activity identifier for the activity engaged in by a user.

6. The system as claimed in claim 5, wherein some of said system context parameters provide an indication of different levels of specificity for the activities performed by the user on the computer.

7. The system as claimed in claim 6, wherein one of the system context parameters comprises an active application parameter, and the state of said active application parameter comprises a name of an application program on the computer, and said means for determining the state of the system context parameter comprises an input component responsive to the active application parameter.

8. The system as claimed in claim 7, wherein the active application parameter comprises information displayed in a caption bar for the application program, and said input component comprises a parser for parsing textual information in said caption bar corresponding to the name of the application program.

9. The system as claimed in claim 6, wherein one of the system context parameters comprises an active document directory parameter, and the state of said active document directory parameter comprises a directory name displayed as textual information in a caption bar, and said means for determining the state of the system context parameter comprises a parser for parsing textual information in said caption bar corresponding to the directory name.

10. The system as claimed in claim 7, wherein one of the system context parameters comprises a name of an active document, and the state of said active document name parameter comprises a file name displayed as textual information in a caption bar for the application program associated with the active document, and said means for determining the state of the system context parameter comprises a parser for parsing textual information in said caption bar corresponding to the active document name.

11. The system as claimed in claim 10, wherein said means for selecting includes a selection component for sequentially looking at said active document name parameter, said active directory name parameter and said active application name parameter.

12. The system as claimed in claim 1, wherein said means for associating comprises an association table stored in memory, said association table having an entry for each activity and each of said entries including one of said activity identifiers, a system parameter, and a parameter state, said system parameter corresponding to said system context parameter, and said parameter state corresponding to the state of said corresponding system context parameter.

13. The system as claimed in claim 12, wherein said means for tracking comprises a multiple user tracking component for tracking multiple users engaged in one or more of the activities on the computer, said multiple user tracking component comprising an entry for each of the activities, and each of said entries including a user identifier, a user activity identifier, and a time log, said user identifier providing an identifier for each user on the computer, and said user activity identifier corresponding to the activity identifier for the activity engaged in by a user.

14. The system as claimed in claim 13, further including a component for creating a backup of said associations table, said component being responsive to termination of an activity by a user for creating said backup.

15. The system as claimed in claim 1, further including a user interface, said user interface including a component for the user to set associations between the activity identifiers and the activities performable on the computer.

16. The system as claimed in claim 15, wherein said user interface further includes a component for the user to create additional activity identifiers and associate said additional activity identifiers with activities engaged in by the user on the computer.

17. A system for monitoring a user's activity on a computer, the computer allowing the user to engage in a number of activities and the computer providing a system context parameter having a plurality of states indicative of the activities engaged by the user on the computer, the system comprising:
(a) a plurality of activity identifiers, each of said activity identifiers corresponding to one of the activities;
(b) link component for linking each said activity identifier with the state of said system context parameter that corresponds to the same activity;
(c) interrogation component for determining the present state of said system context parameter;
(d) selector component responsive to said link component and said interrogation component for selecting said activity identifier corresponding to the present state of said system context parameter; and
(e) tracking component for tracking the user's activity associated with said selected activity identifier.

18. The system as claimed in claim 17, wherein said link component comprises an association table stored in memory, said association table having an entry for each activity and each of said entries including one of said activity identifiers, a system parameter, and a parameter state, said system parameter corresponding to said system context parameter, and said parameter state corresponding to the state of said corresponding system context parameter.

19. The system as claimed in claim 18, wherein said system context parameter comprises information displayed in a caption bar for an application program on the computer, and said interrogation component comprises a parser for parsing textual information in said caption bar corresponding to the state of the system context parameter.

20. The system as claimed in claim 19, wherein said selector component comprises a component for consulting said association table to determine said activity identifier corresponding to said present state of said system context parameter.

21. The system as claimed in claim 20, wherein said tracking component comprises a timer component, said timer component being responsive to changes in the state of said system context parameter for timing the time spent by the user when engaged in the activity indicated by the activity identifier.

22. A method for monitoring activity of a user on a computer, the computer allowing the user to engage in a number of activities and the computer providing a system context parameter having a plurality of states indicative of the activities engaged by the user on the computer, said method comprising the steps of:
(a) providing a plurality of activity identifiers;
(b) associating each of said activity identifiers with one of the activities;
(c) interrogating the system context parameter to determine the state of the system context parameter, the state being indicative of the activity of the user on the computer;
(d) selecting the activity identifier corresponding to the state of said system context parameter;
(e) tracking the activity of the user associated with said selected activity identifier.

23. The method as claimed in claim 22, wherein said step (e) comprises tracking multiple users engaged in one or more of the activities on the computer, and includes associating each of the users for the computer with the activity identifier for the activity engaged in by that user.

24. The method as claimed in claim 22, wherein the system context parameter includes an active application parameter and comprises information displayed in a caption bar for an application program running on the computer, and said step (c) of interrogating comprises parsing information from said caption bar corresponding to the name of the application program.

25. The method as claimed in claim 22, wherein the system context parameter includes an active document directory parameter and comprises information displayed in a caption bar for an application program running on the computer, and said step (c) of interrogating comprises parsing information from said caption bar corresponding to the document directory for the application program.

26. The method as claimed in claim 22, wherein the system context parameter includes an active document parameter and comprises information displayed in a caption bar for an application program running on the computer, and said step (c) of interrogating comprises parsing information from said caption bar corresponding to a name of the document in the application program.

27. A method of monitoring a user's activity on a computer, the computer allowing the user to engage in a number of activities and the computer providing a system context parameter having a plurality of states indicative of the activities engaged by the user on the computer, said method comprising the steps of:
(a) associating an activity with an activity identifier;
(b) associating said activity identifier with a state of the system parameter, the state of the system parameter being indicative of the activity corresponding to said activity identifier;
(c) monitoring the present state of the system parameter;
(d) determining said activity identifier corresponding to the present state of the system parameter; and
(e) storing said activity identifier determined in step (d), and tracking the user's activity on the computer based on said activity identifier.

28. A computer program product for use on a computer system for monitoring activity of a user on a computer, the computer allowing the user to engage in a number of activities and the computer providing a system context parameter having a plurality of states indicative of the activities engaged by the user on the computer, said computer program comprising:
(a) a recording medium;
(b) means recorded on said medium for instructing the computer system to perform the steps of:
(i) providing a plurality of activity identifiers;
(ii) associating each of said activity identifiers with one of the activities;
(ii) interrogating the system context parameter to determining the state of the system context parameter, and the state being indicative of the activity of the user on the computer;
(iv) selecting the activity identifier corresponding to the state of said system context parameter;
(v) tracking the activity of the user associated with said selected activity identifier.
